(19) United States
(12) Patent Application Publication
(10) Pub. No.: US 2003/0070941 A1
(43) Pub. Date: Apr. 17, 2003

(54) Apparatus and method for evaluating plating solution and apparatus and method for fabricating electronic device

(75) Inventor: Shuji Hirao, Niigata (JP)

Correspondence Address: NIXON PEABODY, LLP, 8180 GREENSBORO DRIVE, SUITE 800, MCLEAN, VA, 22102, US

(73) Assignee: MATSUHITA ELECTRIC INDUSTRIAL CO., LTD., Osaka (JP)

(21) Appl. No.: 10/271,724

(22) Filed: Oct. 17, 2002

(30) Foreign Application Priority Data
Oct. 17, 2001 (JP) 2001-318819

(51) Int. Cl. C25B 9/00; C25C 3/16; C25C 3/20; B23H 7/14; C25F 7/00; C25B 9/04; C25B 15/00

(52) U.S. Cl. 205/775; 204/230.1

(57) ABSTRACT

A value of a current flowing through a plating solution to a first working electrode whose base is exposed in a first opening is measured, and a value of a current flowing through the plating solution to a second working electrode whose base is exposed in a second opening having an opening area larger than that of the first opening is measured.

### BACKGROUND OF THE INVENTION

The present invention relates to a method for evaluating a plating solution used in electroplating, and more particularly, it relates to a method for analyzing the usefulness of an additive included in a plating solution used in electroplating for burying a metal film in an interconnect forming recess provided on a substrate.

Recently, for increasing the degree of integration and the speed of a semiconductor integrated circuit (LSI), copper that has resistance lower than that of aluminum and has high electromigration (EM) resistance is regarded as a promising interconnect material of the next generation. Also, copper film formation by copper electroplating has been started to be employed as a film formation technique for an LSI.

FIGS. 8A through 8C are cross-sectional views for showing procedures in a first conventional method for fabricating an electronic device, and more specifically, a method for forming a copper interconnect by the copper electroplating.

First, as shown in FIG. 8A, after depositing an interlayer insulating film 11 on a semiconductor substrate 10, an interconnect groove 12 in an interconnect pattern and a contact hole 13 reaching a lower interconnect or semiconductor device are formed in the interlayer insulating film 11 by known lithography and dry etching. Thereafter, a tantalum nitride film 14 with a thickness of 30 nm, which functions as an adhesion layer between the interlayer insulating film 11 and an interconnect copper film formed in a subsequent step, is deposited over the interlayer insulating film 11 including the interconnect groove 12 and the contact hole 13 by sputtering. Then, a seed copper film 15 with a thickness of 150 nm, which functions as a seed layer in subsequent electroplating, is deposited on the tantalum nitride film 14 by the sputtering.

Next, as shown in FIG. 8B, a plated copper film 16 is grown on the seed copper film 15 by the electroplating. At this point, the seed copper film 15 tends to overhang at the mouth (i.e., a portion A of FIG. 8A) of the contact hole 13, and hence, particularly in the case where the diameter of the contact hole 13 is 0.3 μm or less, the shape of the plated copper film 16 buried by the electroplating tends to be defective. Specifically, when the plated copper film 16 is uniformly grown by the plating on the seed copper film 15, the mouth of the contact hole 13 is closed before filling the contact hole 13 with the plated copper film 16 as shown in FIG. 8B, so that a void 17 can be formed within the contact bole 13. Even when the plating growth is further continued thereafter, the void 17 cannot be filled with the plated copper film 16. A similar phenomenon also occurs within the interconnect groove 12.

Next, as shown in FIG. 8C, portions of the plated copper film 16, the seed copper film 15 and the tantalum nitride film 14 formed outside the interconnect groove 12 and the contact hole 13 are removed by chemical mechanical polishing, so as to form a copper interconnect 18 and a copper electrode 19. However, the voids 17 formed within the copper interconnect 18 and the copper electrode 19 degrade the characteristic and the reliability of the resultant electronic device, and hence, the yield is largely lowered.

In order to overcome the problem of the void formed within a contact hole and the like, electroplating using a plating bath (namely, a plating solution contained in a plating tank) including an inhibitor for inhibiting plating growth and an accelerator for accelerating the plating growth is now being examined. Specifically, as the inhibitor, for example, macromolecular polyethylene glycol, polypropylene glycol or a polymer thereof each having a molecular weight exceeding 1000 is used, and as the accelerator, for example, a sulfur organic compound having a comparatively small molecular weight, such as sulfonic acid, is used. Hereinafter, the inhibitor and the accelerator are together sometimes referred to as an additive.

FIGS. 9A through 9C are cross-sectional views for showing procedures in a second conventional method for fabricating an electronic device, and more particularly, a method for forming a copper interconnect by the copper electroplating using a plating solution including an additive. In FIGS. 9A through 9C, like reference numerals are used to refer to like elements used in the first conventional method shown in FIGS. 8A through 8C so as to omit the description.

FIG. 9A is a cross-sectional view for showing an electronic device at the beginning of the plating growth of the plated copper film 16. As shown in FIG. 9A, although an inhibitor 20 and an accelerator 21 are included in the plating bath (not shown), since the inhibitor 20 has a physical size as large as approximately several tens nm, the inhibitor 20 is minimally diffused within the contact hole 13 or the interconnect groove 12. As a result, as shown in FIG. 9B, the concentration of the inhibitor 20 is lower and the depositing rate of the plated copper film 16 is higher toward the bottom of the contact hole 13 or the interconnect groove 12. Owing to such electroplating, the contact hole 13 or the interconnect groove 12 can be filled without forming a void with the plated copper film 16 grown from the bottom of the contact hole 13 or the interconnect groove 12 before the mouth of the contact hole 13 or the interconnect groove 12 is closed by the plated copper film 16 as shown in FIG. 9C.

In the above-described copper electroplating for forming an interconnect of an LSI using the plating solution including the additive, differently from general decorative plating and the like, it is necessary to precisely control the concentration balance between the accelerator and the inhibitor in the plating solution in order to bury plating in a fine opening of a submicron size without forming a void. In other words, the electroplating employed for forming an interconnect and the like of an LSI is realized depending upon not only the concentration balance of principal constituents of the plating solution but also the concentration balance of small amounts of additives, and it is significant to keep the concentration of each constituent including the additives within an allowable range.

Accordingly, concentration analysis of additives such as a brightener, an inhibitor and a leveling agent included in a plating solution is recently performed by a CVS (Cyclic Voltammetric Stripping) method.

FIG. 10A shows the rough structure of a conventional plating solution evaluation apparatus, and specifically, a CVS apparatus.

As shown in FIG. 10A, the conventional CVS apparatus includes a potentiostat 30, a working electrode 31 which is connected to the potentiostat 30 and to which potential is applied by the potentiostat 30, a reference electrode 32 connected to the potentiostat 30 and serving as a reference of the potential of the working electrode 31, an auxiliary electrode 33 connected to the potentiostat 30 and functioning as an anode, and a personal computer (PC) 34 for performing predetermined processing on the basis of the value of a current flowing to the working electrode 31 measured by the potentiostat 30. The working electrode 31, the reference electrode 32 and the auxiliary electrode 33 are immersed in a plating solution 41 contained in a plating tank 40. The working electrode 31 has a cylindrical structure, for example, as shown in FIG. 10B, in which platinum 31a is exposed on a surface corresponding to the bottom when it is immersed in the plating solution 41. The exposed surface of the platinum 31a is flat, and the other portion of the platinum 31a apart from the exposed surface is covered with an insulator 31b. On the other hand, the reference electrode 32 is made from silver and silver chloride, and the auxiliary electrode 33 is made from a conducting material, such as platinum, capable of depositing metal ions by the plating. When the copper electroplating is performed, the principal constituents of the plating solution 41 are, for example, H₂SO₄ (in a concentration of approximately 180 g/l), CuSO₄.5H₂O (in a concentration of approximately 70 g/l) and HCl (in a concentration of approximately 50 mg/l). Also, a stirrer 42 for stirring the plating solution 41 is provided on the bottom of the plating tank 40.

In the CVS apparatus of FIG. 10A, when the potential of the working electrode 31 on the basis of the reference electrode 32 (hereinafter simply referred to as the potential of the working electrode 31) is reciprocated within a predetermined range, an oxidation-reduction current flows to the working electrode 31 (more specifically, between the working electrode 31 and the auxiliary electrode 33). This oxidation-reduction current corresponds to the amount of plating deposited on the working electrode 31, and hence, the amount of deposited plating can be obtained by measuring the oxidation-reduction current with the potentiostat 30. Accordingly, the concentration of an additive included in the plating solution 41 can be measured by utilizing the dependency, on the concentration of the additive, of the amount of plating deposited on the working electrode 31. Now, this measurement will be specifically described with reference to FIG. 10C.

FIG. 10C shows the relationship between the potential (E) of the working electrode 31 and the current (I) flowing to the working electrode 31 obtained by the plating solution evaluation method (more specifically, a method for measuring the concentration of an additive included in the plating solution) by using the CVS apparatus of FIG. 10A.

First, even when the potential of the working electrode 31 is lowered, no current flows to the working electrode 31 (as shown with an arrow a₀). When the potential of the working electrode 31 is further lowered, a reduction current of Cu ions flows to the working electrode 31 (as shown with an arrow b₀). At this point, reduced Cu deposits on the working electrode 31. Next, when the potential of the working electrode 31 is started to be increased, the amplitude (absolute value) of the current flowing to the working electrode 31 is decreased (as shown with an arrow c₀). When the potential of the working electrode 31 is further increased, an oxidation current starts to flow to the working electrode 31 (as shown with an arrow d₀), and hence, the Cu having been deposited on the working electrode 31 is oxidized so as to be dissolved in the solution. Thereafter, when the Cu on the working electrode 31 is entirely dissolved, the current flowing to the working electrode 31 becomes minimal (as shown with arrows e₀ and f₀). When these procedures are repeated, namely, when the potential of the working electrode 31 is reciprocated within a predetermined range, deposition and dissolution of Cu on the working electrode 31 are alternately repeated. At this point, the current flowing to the working electrode 31 is measured, so as to obtain the amount of deposited Cu on the basis of the measured current value. Furthermore, the dependency of the amount of deposited Cu on the concentration of an additive is utilized, so as to obtain the concentration of the additive included in the plating solution 41. It is noted that the plating solution 41 is stirred with the stirrer 42 or the like during the measurement of the additive concentration.

In the electroplating, a plating solution having been introduced to a substrate to be plated for the plating processing is generally recovered to be repeatedly reused for the plating processing. In such a case, the additive included in the plating solution loses its original effect because it is decomposed, oxidized or reduced due to the influence of the plating processing and the like. Therefore, it is necessary to properly measure the concentration of the additive included in the plating solution, so that a shortage of the additive can be supplied on the basis of the result of the measurement.

In accordance with the refinement of devices, however, there has arisen a problem that formation of a void in a copper interconnect, namely, defective burying, cannot be avoided in the formation of the copper interconnect by the copper electroplating using a plating solution including an additive as shown in FIGS. 9A through 9C even by controlling the concentration of the additive by using the conventional CVS apparatus (shown in FIG. 10A).

### SUMMARY OF THE INVENTION

In consideration of the above-described conventional problem, an object of the invention is definitely burying a metal film by electroplating in an interconnect forming recess provided on a substrate to be plated.

In order to achieve the object, the present inventor has examined the cause of the occurrence of defective burying even with the concentration control of an additive of a plating solution by using the conventional CVS apparatus, resulting in finding the following:

A portion of the additive that has lost its original effect due to the influence of the plating processing or the like, namely, a reaction by-product produced through decomposition or the like of the additive, accumulates in the plating bath. As a result, the accumulated by-product causes the defective burying in, for example, burying a plated metal film in an interconnect forming recess provided on a substrate to be plated. This will now be described in detail with reference to FIGS. 11A through 11C.

FIGS. 11A through 11C are cross-sectional views for showing the defective burying caused by a reaction by-product in the second conventional method for fabricating an electronic device. In FIGS. 11A through 11C, like reference numerals are used to refer to like elements used in the first conventional method shown in FIGS. 8A through 8C and in the second conventional method shown in FIGS. 9A through 9C, so as to omit the description.

FIG. 11A is a cross-sectional view of an electronic device obtained at the beginning of plating growth of the plated copper film 16. At this point, as shown in FIG. 11A, the plating bath (not shown) contains, in addition to the inhibitor 20 and the accelerator 21, for example, a reaction by-product 20A of the inhibitor 20. Specifically, in the case where the inhibitor 20 is generally used polyethylene glycol, polypropylene glycol or a polymer thereof (each having an average molecular weight of several thousands through several ten thousands), the reaction by-product 20A is a low-molecular polymer produced through decomposition of the inhibitor 20. In this case, the inhibitor 20 is minimally diffused into the contact hole 13 or the interconnect groove 12 while the reaction by-product 20A can easily diffuse into the contact hole 13 or the interconnect groove 12. As a result, as shown in FIG. 11B, the concentration of the reaction by-product 20A is not lowered toward the bottom of the contact hole 13 or the interconnect groove 12, and hence, the plating growth of the plated copper film 16 is inhibited within the contact hole 13 or the interconnect groove 12. Therefore, as shown in FIG. 11C, a void 17 is formed within the contact hole 13 or the interconnect groove 12.

Specifically, in the copper electroplating for forming an interconnect of an LSI by using a plating solution including an additive, it is necessary to wholly or partly exchange the plating solution before the occurrence of the defective burying derived from the accumulation of a reaction by-product in the plating solution. However, even when the conventional CVS apparatus (as shown in FIGS. 10A and 10B) equipped with the working electrode 31 having an exposed flat metal surface is used, the influence of the reaction by-product within a fine opening such as the contact hole 13 cannot be evaluated. In other words, the concentration of the reaction by-product cannot be measured separately from the concentration of the additive, and hence, the influence of the additive cannot be distinguished from the influence of the reaction by-product. Accordingly, the plating solution cannot be exchanged at good timing before the occurrence of the defective burying.

Although the reaction by-product 20A of the inhibitor 20 is exemplified as the cause of the defective burying in the above description, the same problem is caused by a reaction by-product of the accelerator 21 (which has lost the original effect as the accelerator) produced by, for example, cutting bond between molecules of the accelerator 21 through the plating processing or the like.

Also, if the plating solution is exchanged ahead of time in order to definitely prevent the occurrence of the defective burying, this increases the fabrication cost. Furthermore, in order to accurately determine the timing for exchanging the plating solution, the actual burying of the plated metal film within a fine opening may be checked everyday with an FIB (focused ion beam) or an SEM (scanning electron microscope), which is not practical in consideration of time and cost.

The present invention was devised on the basis of the aforementioned finding. Specifically, the plating solution evaluation apparatus of this invention for evaluating an electroplating solution including an additive includes a first working electrode including a first conducting layer, a first insulating layer covering the first conducting layer and a first opening formed in the first insulating layer for exposing the first conducting layer; a second working electrode including a second conducting layer, a second insulating layer covering the second conducting layer and a second opening that is formed in the second insulating layer for exposing the second conducting layer and has an opening area larger than that of the first opening; and current measuring means for measuring a value of a current flowing to one electrode out of the first working electrode and the second working electrode with potential on the basis of a reference electrode selectively applied to the one electrode.

Thus, the plating solution evaluation apparatus of this invention includes the first working electrode in which the first conducting layer is exposed in the first opening, the second working electrode in which the second conducting layer is exposed in the second opening having the opening area larger than that of the first opening, and the current measuring means for individually measuring the value of the current flowing to each working electrode. Therefore, when the opening diameter and the depth of the first opening is set to be equivalent to those of an interconnect forming recess, namely, a fine opening, provided on a substrate to be plated, the amount of deposited plating, namely, the plating rate (i.e., the amount of deposited plating per unit time), within the fine opening can be compared with the plating rate outside the fine opening, namely, on the substrate to be plated. In other words, the influence of an additive and its reaction by-product included in the electroplating solution on the plating growths respectively inside and outside of the fine opening can be directly obtained. Therefore, the degree of degradation of the electroplating solution can be precisely evaluated in a short time, so that time when defective burying of a plated metal film occurs in the fine opening, namely, time for exchanging the electroplating solution, can be obtained precisely in a short time. Accordingly, the electroplating solution can be exchanged at good timing before the occurrence of the defective burying, and hence, a metal film can be definitely buried in the interconnect forming recess provided on the substrate to be plated by the electroplating without wasting cost and time.

In the plating solution evaluation apparatus of this invention, the first opening preferably has an opening diameter and a depth equivalent to those of an interconnect forming recess having the largest aspect ratio among one or more interconnect forming recesses provided on a substrate to be plated by using the electroplating solution.

Thus, the time for exchanging the electroplating solution can be more precisely obtained.

The plating solution evaluation method of this invention for evaluating an electroplating solution including an additive includes the steps of measuring a value of a first current flowing to a first working electrode, which includes a first conducting layer, a first insulating layer covering the first conducting layer and a first opening formed in the first insulating layer for exposing the first conducting layer, with the first working electrode immersed in the electroplating solution and with first potential on the basis of a reference electrode applied to the first working electrode; and measuring a value of a second current flowing to a second working electrode, which includes a second conducting layer, a second insulating layer covering the second conducting layer and a second opening that is formed in the second insulating layer for exposing the second conducting layer and has an opening area larger than that of the first opening, with the second working electrode immersed in the electroplating solution and with second potential on the basis of the reference electrode applied to the second working electrode.

In the plating solution evaluation method of this invention, the value of the first current flowing through the electroplating solution to the first working electrode in which the first conducting layer is exposed in the first opening is measured, and the value of the second current flowing through the electroplating solution to the second working electrode in which the second conducting layer is exposed in the second opening having an opening area larger than that of the first opening is measured. Therefore, when the opening diameter and the depth of the first opening are set to be equivalent to those of a fine opening provided on a substrate to be plated, the plating rate within the fine opening can be compared with the plating rate on the substrate to be plated. Specifically, the influence of an additive and its reaction by-product included in the electroplating solution on the plating growths respectively inside and outside of the fine opening can be directly obtained. Therefore, the degree of degradation of the electroplating solution can be evaluated precisely in a short time, so that the time when the defective burying of a plated metal film occurs within the fine opening, namely, the time for exchanging the electroplating solution, can be precisely obtained in a short time. Accordingly, the electroplating solution can be exchanged at good timing before the occurrence of the defective burying, and hence, a metal film can be definitely buried in the fine opening, and specifically, in an interconnect forming recess, provided on the substrate to be plated without wasting cost and time.

The plating solution evaluation method of this invention preferably further includes the steps of calculating a current density of the first current on the basis of the opening area of the first opening and the measured value of the first current; calculating a current density of the second current on the basis of the opening area of the second opening and the measured value of the second current; and calculating a ratio of the current density of the first current to the current density of the second current.

Thus, the degree of the degradation of the electroplating solution, namely, the time for exchanging the electroplating solution, can be easily and definitely obtained by merely comparing the calculated ratio with the prescribed value previously calculated through an experiment or the like.

In the plating solution evaluation method of this invention, the first opening preferably has an opening diameter and a depth equivalent to those of an interconnect forming recess having the largest aspect ratio among one or more interconnect forming recesses provided on a substrate to be plated by using the electroplating solution.

Thus, the time for exchanging the electroplating solution can be more precisely obtained.

The plating solution control method of this invention for controlling an electroplating solution including an additive includes the steps of measuring a value of a first current flowing to a first working electrode, which includes a first conducting layer, a first insulating layer covering the first conducting layer and a first opening formed in the first insulating layer for exposing the first conducting layer, with the first working electrode immersed in the electroplating solution and with first potential on the basis of a reference electrode applied to the first working electrode; measuring a value of a second current flowing to a second working electrode, which includes a second conducting layer, a second insulating layer covering the second conducting layer and a second opening that is formed in the second insulating layer for exposing the second conducting layer and has an opening area larger than that of the first opening, with the second working electrode immersed in the electroplating solution and with second potential on the basis of the reference electrode applied to the second working electrode; calculating a current density of the first current on the basis of the opening area of the first opening and the measured value of the first current; calculating a current density of the second current on the basis of the opening area of the second opening and the measured value of the second current; calculating a ratio of the current density of the first current to the current density of the second current; and comparing the calculated ratio with a given value, and when the calculated ratio is smaller than the given value, exchanging part or whole of the electroplating solution with a fresh electroplating solution.

In the plating solution control method of this invention, the electroplating solution is exchanged by using the plating solution evaluation method of this invention, and hence, a metal film can be definitely buried in an interconnect forming recess without wasting cost and time. Also, the ratio of the current density of the first current flowing to the first working electrode to the current density of the second current flowing to the second working electrode is calculated to be compared with the prescribed value, and the electroplating solution is exchanged on the basis of the result of the comparison. Therefore, the electroplating solution can be exchanged easily at good timing.

In the plating solution control method of this invention, the first opening preferably has an opening diameter and a depth equivalent to those of an interconnect forming recess having the largest aspect ratio among one or more interconnect forming recesses provided on a substrate to be plated by using the electroplating solution.

Thus, the time for exchanging the electroplating solution can be more precisely obtained.

The method of this invention for fabricating a plating solution evaluation apparatus for evaluating an electroplating solution including an additive, includes a step of forming a working electrode, and the step of forming a working electrode includes the sub-steps of forming a conducting layer corresponding to a base of the working electrode on a substrate covered with a first insulating film; forming a second insulating film on the conducting film; forming an opening reaching the conducting film in the second insulating film; and exposing the conducting film by partly removing the second insulating film, whereby forming a takeoff electrode portion.

In the method for fabricating a plating solution evaluation apparatus of this invention, the first or second working electrode of the plating solution evaluation apparatus of this invention can be easily and definitely fabricated.

In the method for fabricating a plating solution evaluation apparatus of this invention, the opening preferably has an opening diameter and a depth equivalent to those of an interconnect forming recess having the largest aspect ratio among one or more interconnect forming recesses provided on a substrate to be plated by using the electroplating solution.

Thus, the time for exchanging the electroplating solution can be precisely obtained by using the resultant working electrode (i.e., the first working electrode of the plating solution evaluation apparatus of this invention).

The apparatus for fabricating an electronic device of this invention in which a substrate having one or more interconnect forming recesses is immersed in a plating solution for burying a metal film in the interconnect forming recesses by electroplating, includes a first working electrode including a first conducting layer, a first insulating layer covering the first conducting layer, and a first opening that is formed in the first insulating layer for exposing the first conducting layer and has an opening diameter and a depth equivalent to those of one of the interconnect forming recesses; a second working electrode including a second conducting layer, a second insulating layer covering the second conducting layer, and a second opening that is formed in the second insulating layer for exposing the second conducting layer and has an opening area larger than that of the first opening; and current measuring means for independently measuring a value of a current flowing to one electrode out of the first working electrode and the second working electrode with potential on the basis of a reference electrode selectively applied to the one electrode.

Thus, the apparatus for fabricating an electronic device of this invention includes the first working electrode in which the first conducting layer is exposed in the first opening having an opening diameter and a depth equivalent to those of the interconnect forming recess provided on the substrate to be plated, the second working electrode in which the second conducting layer is exposed in the second opening having the opening area larger than that of the first opening, and the current measuring means for individually measuring the value of the current flowing to each working electrode. Therefore, the amount of deposited plating, namely, the plating rate (i.e., the amount of deposited plating per unit time), within the interconnect forming recess can be compared with the plating rate outside the interconnect forming recess, namely, on the substrate to be plated. In other words, the influence of an additive and its reaction by-product included in the electroplating solution on the plating growths respectively inside and outside of the interconnect forming recess can be directly obtained. Therefore, the degree of degradation of the electroplating solution can be precisely evaluated in a short time, so that time when defective burying of a plated metal film occurs in the interconnect forming recess, namely, time for exchanging the electroplating solution, can be obtained precisely in a short time. Accordingly, the electroplating solution can be exchanged at good timing before the occurrence of the defective burying, and hence, a metal film can be definitely buried in the interconnect forming recess by the electroplating without wasting cost and time.

In the apparatus for fabricating an electronic device of this invention, the first opening preferably has an opening diameter and a depth equivalent to those of one interconnect forming recess having the largest aspect ratio among the interconnect forming recesses.

Thus, the time for exchanging the electroplating solution can be more precisely obtained.

The method for fabricating an electronic device of this invention includes the steps of forming one or more interconnect forming recesses in an interlayer insulating film formed on a substrate; and burying a metal film in the interconnect forming recesses by electroplating with the substrate immersed in a plating solution, and the step of burying a metal film includes the sub-steps of measuring a value of a first current flowing to a first working electrode, which includes a first conducting layer, a first insulating layer covering the first conducting layer and a first opening that is formed in the first insulating layer for exposing the first conducting layer and has an opening diameter and a depth equivalent to those of one of the interconnect forming recesses, with the first working electrode immersed in the plating solution and with first potential on the basis of a reference electrode applied to the first working electrode; and measuring a value of a second current flowing to a second working electrode, which includes a second conducting layer, a second insulating layer covering the second conducting layer, and a second opening that is formed in the second insulating layer for exposing the second conducting layer and has an opening area larger than that of the first opening, with the second working electrode immersed in the plating solution and with second potential on the basis of the reference electrode applied to the second working electrode.

In the method for fabricating an electronic device of this invention, the plating solution evaluation method of this invention is employed in filling a metal film in an interconnect forming recess by the electroplating by immersing a substrate having the interconnect forming recess in the plating solution. Therefore, the plating rate within the interconnect forming recess can be compared with the plating rate outside the interconnect forming recess, namely, on the substrate. In other words, the influence of an additive and its reaction by-product included in the plating solution on the plating growths respectively inside and outside of the interconnect forming recess can be directly obtained. Therefore, the degree of the degradation of the plating solution can be precisely evaluated in a short time, and hence, the time when the defective burying of a metal film occurs within the interconnect forming recess, namely, the time for exchanging the plating solution, can be precisely obtained in a short time. Accordingly, the plating solution can be exchanged at good timing before the occurrence of the defective burying, and hence, the metal film can be definitely buried in the interconnect forming recess by the electroplating without wasting cost and time.

The method for fabricating an electronic device of this invention preferably further includes the steps of calculating a current density of the first current on the basis of the opening area of the first opening and the measured value of the first current; calculating a current density of the second current on the basis of the opening area of the second opening and the measured value of the second current; calculating a ratio of the current density of the first current to the current density of the second current; and comparing the calculated ratio with a given value, and when the calculated ratio is smaller than the given value, exchanging part or whole of the plating solution with a fresh plating solution.

Thus, the electroplating solution can be exchanged easily at good timing.

In the method for fabricating an electronic device of this invention, the first opening preferably has an opening diameter and a depth equivalent to those of an interconnect forming recess having the largest aspect ratio among the interconnect forming recesses.

Thus, the time for exchanging the electroplating solution can be more precisely obtained.

### BRIEF DESCRIPTION OF THE DRAWINGS

FIGS. 1A, 1B and 1C are cross-sectional views for showing procedures in a method for fabricating an electronic device according to Embodiment 1 of the invention;

FIGS. 2A and 2B are diagrams for showing an exemplified rough structure of a plating solution evaluation apparatus according to Embodiment 1 of the invention;

FIG. 3A is a diagram for showing the relationship between a current flowing to a second working electrode and potential of the second working electrode obtained by a plating solution evaluation method according to Embodiment 1 and FIG. 3B is a diagram for showing the relationship between a current flowing to a first working electrode and potential of the first working electrode obtained by the plating solution evaluation method of Embodiment 1;

FIG. 4 is a diagram for showing another exemplified rough structure of the plating solution evaluation apparatus of Embodiment 1;

FIG. 5 is a diagram for showing an exemplified method for obtaining a prescribed value K employed in the plating solution evaluation method of Embodiment 1;

FIG. 6 is a diagram for showing a method for determining time for exchanging a plating solution on the basis of the prescribed value K in the plating solution evaluation method of Embodiment 1;

FIGS. 7A, 7B, 7C and 7D are cross-sectional views for showing procedures in a method for fabricating a plating solution evaluation apparatus according to Embodiment 2 of the invention;

FIGS. 8A, 8B and 8C are cross-sectional views for showing procedures in a first conventional method for fabricating an electronic device;

FIGS. 9A, 9B and 9C are cross-sectional views for showing procedures in a second conventional method for fabricating an electronic device;

FIG. 10A is a diagram for showing the rough structure of a conventional plating solution evaluation apparatus, FIG. 10B is a perspective view of a working electrode of the conventional plating solution evaluation apparatus and FIG. 10C is a diagram for showing the relationship between potential of the working electrode and a current flowing to the working electrode obtained by a plating solution evaluation method using the conventional plating solution evaluation apparatus of FIG. 10A; and

FIGS. 11A, 11B and 11C are diagrams for showing defective burying caused by a reaction by-product in the second conventional method for fabricating an electronic device.

### DETAILED DESCRIPTION OF THE INVENTION

### EMBODIMENT 1

An apparatus for fabricating an electronic device (specifically, a plating solution evaluation apparatus for use in fabrication of an electronic device) and a method for fabricating an electronic device (specifically, a method for evaluating and controlling a plating solution for use in fabrication of an electronic device) according to Embodiment 1 of the invention will now be described with reference to the accompanying drawings.

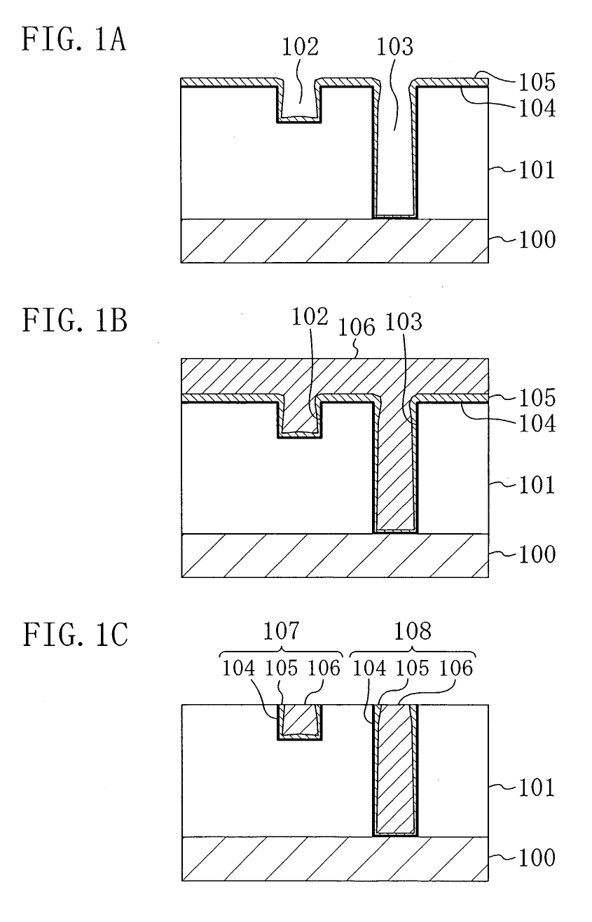

FIGS. 1A through 1C are cross-sectional views for showing procedures in the method for fabricating an electronic device, and specifically, in a method for forming a copper interconnect by copper electroplating, according to Embodiment 1.

First, as shown in FIG. 1A, after depositing an interlayer insulating film 101 on a semiconductor substrate 100, an interconnect groove 102 in an interconnect pattern and a contact hole 103 reaching a lower interconnect or semiconductor device are formed in the interlayer insulating film 101 by known lithography and dry etching. Thereafter, a tantalum nitride film 104 with a thickness of approximately 30 nm, which functions as an adhesion layer between the interlayer insulating film 101 and an interconnect copper film formed in a subsequent procedure, is deposited over the interlayer insulating film 101 including the interconnect groove 102 and the contact hole 103 by sputtering. Then, a seed copper film 105 with a thickness of approximately 150 nm functioning as a seed layer in subsequent electroplating is deposited on the tantalum nitride film 104 by the sputtering.

Next, as shown in FIG. 1B, the semiconductor substrate 100 is immersed in a plating solution (not shown) for growing a plated copper film 106 on the seed copper film 105 by electroplating, so as to completely fill the interconnect groove 102 and the contact hole 103 with the plated copper film 106. At this point, in order to prevent a void from being formed within the contact hole 103 and the like, an inhibitor for inhibiting the plating growth and an accelerator for accelerating the plating growth are included in the plating solution.

Then, as shown in FIG. 1C, portions of the plated copper film 106, the seed copper film 105 and the tantalum nitride film 104 formed outside the interconnect groove 102 and the contact hole 103 are removed by chemical mechanical polishing. Thus, a copper interconnect 107 and a copper electrode 108 are formed.

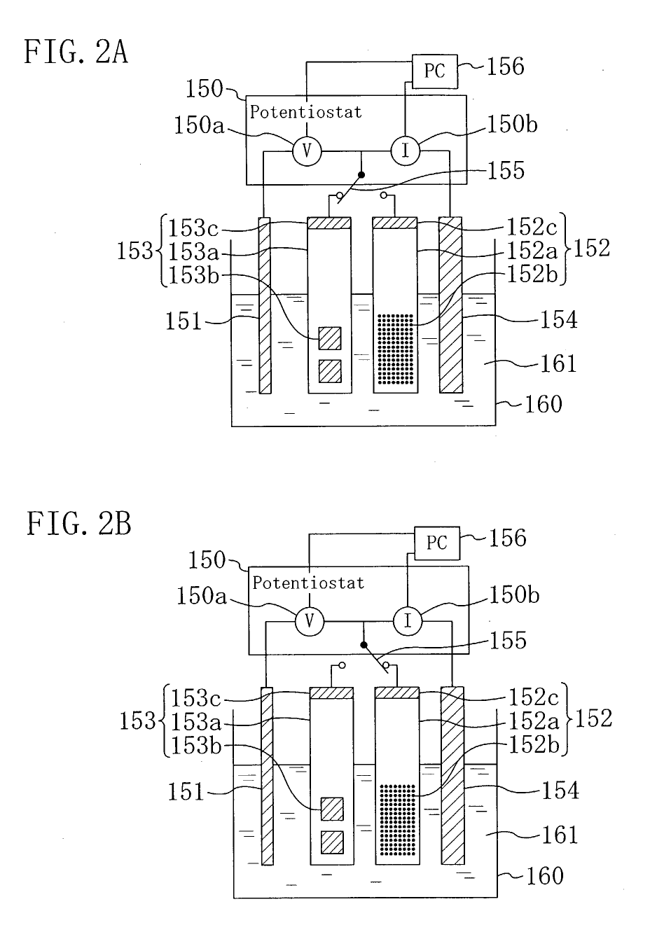

FIGS. 2A and 2B show the rough structure of a plating solution evaluation apparatus of this embodiment used in the plating processing shown in FIG. 1B.

As shown in FIGS. 2A and 2B, the plating solution evaluation apparatus of this embodiment includes a potentiostat 150; a reference electrode 151 connected to the potentiostat 150; a first working electrode 152 and a second working electrode 153 that are connected to the potentiostat 150 and to which potential is applied by the potentiostat 150; an auxiliary electrode 154 that is connected to the potentiostat 150 and functions as an anode; a switch 155 for switching the connection between the potentiostat 150 and the first working electrode 152 or the second working electrode 153; and a personal computer (PC) 156 for performing predetermined processing on the basis of a value of a current flowing to the first working electrode 152 or the second working electrode 153 measured by the potentiostat 150. FIG. 2A shows a state where the potentiostat 150 and the second working electrode 153 are connected to each other via the switch 155, and FIG. 2B shows a state where the potentiostat 150 and the first working electrode 152 are connected to each other via the switch 155.

The potentiostat 150 includes a voltmeter 150a for measuring the potential (on the basis of the reference electrode 151) applied to the first working electrode 152 or the second working electrode 153, and an ammeter 150b for measuring a current flowing to the first working electrode 152 or the second working electrode 153 (specifically, a current flowing between the first working electrode 152 or the second working electrode 153 and the auxiliary electrode 154). Also, the potentiostat 150 can control the value of the potential applied to the first working electrode 152 or the second working electrode 153.

The reference electrode 151, the first working electrode 152, the second working electrode 153 and the auxiliary electrode 154 are immersed in a plating solution 161 contained in a plating tank 160.

In this embodiment, the plating tank 160 corresponds to a plating tank (hereinafter referred to as the plating chamber) in which the plating processing shown in FIG. 1B is performed. Specifically, in the plating solution evaluation apparatus of this embodiment, while the plating processing shown in FIG. 1B is being performed, the plating solution in which the semiconductor substrate 100 is immersed can be evaluated. It is noted that, in the plating chamber 160 shown in FIGS. 2A and 2B, the semiconductor substrate 100 corresponding to a substrate to be plated and various equipment used in a general electroplating apparatus, such as a wafer holder for holding the semiconductor substrate 100, a mechanism for immersing the wafer holder in the plating solution 161, an anode electrode for the substrate to be plated and a masking shield for controlling electric field distribution within the plating solution 161, are omitted for the sake of simplification. Similarly, although omitted in the drawings, a stirrer for stirring the plating solution 161 may be provided on the bottom of the plating chamber 160.

As shown in FIGS. 2A and 2B, a conducting layer (hereinafter referred to as the first conducting layer) corresponding to the base of the first working electrode 152 is covered with a first insulating layer 152a. Also, a portion of the first insulating layer 152a immersed in the plating solution 161 is provided with at least one fine first opening 152 for exposing the first conducting layer. Furthermore, a first takeoff electrode portion 152c made from the exposed first conducting layer is provided at the end of the first working electrode 152 not immersed in the plating solution 161. At this point, each first opening 152b preferably has an opening diameter and a depth equivalent to those of a recess (for example, the contact hole 103) having the largest aspect ratio that is the most difficult to fill by the plating among the interconnect groove 102 and the contact hole 103, namely, among all the interconnect forming recesses, provided on the semiconductor substrate 100. Furthermore, the number of first openings 152b is preferably large so that the amplitude of a current flowing to the first working electrode 152 can be easily measured.

Moreover, as shown in FIGS. 2A and 2B, a conducting layer (hereinafter referred to as the second conducting layer) corresponding to the base of the second working electrode 153 is also covered with a second insulating layer 153a. Also, a portion of the second insulating layer 153a immersed in the plating solution 161 is provided with at least one second opening 153b, which is sufficiently larger than the first opening 152b, for exposing the second conducting layer. A second takeoff electrode portion 153c made from the exposed second conducting layer is provided at the end of the second working electrode 153 not immersed in the plating solution 161. At this point, if the area of the exposed second conducting layer immersed in the plating solution 161 is constant, a lower portion of the second working electrode 153 may not be covered with the second insulating layer 153a.

The reference electrode 151 is made from silver and silver chloride, and the first and second conducting layers corresponding to the bases of the first working electrode 152 and the second working electrode 153 and the auxiliary electrode 154 are made from a conducting material capable of depositing metal ions by the plating, such as platinum, gold, silver, copper, stainless steel, nickel, chromium, zinc and tin.

In the case where the copper electroplating is performed in the plating processing shown in FIG. 1B, the principal constituents of the plating solution 161 are, for example, H₂SO₄ (in a concentration of approximately 180 g/l), CuSO₄.5H₂O (in a concentration of approximately 70 g/l) and HCl (in a concentration of approximately 50 mg/l).

As another characteristic of this embodiment, the values of currents respectively flowing to the first working electrode 152 and the second working electrode 153 can be independently measured by using the switch 155. As still another characteristic of this embodiment, a ratio of the current density of the current flowing to the first working electrode 152 (specifically, the current flowing between the first working electrode 152 and the auxiliary electrode 154) to the current density of the current flowing to the second working electrode 153 (specifically, the current flowing between the second working electrode 153 and the auxiliary electrode 154) can be obtained by using the personal computer 156.

Now, the method for evaluating and controlling a plating solution by using the plating solution evaluation apparatus of this embodiment shown in FIGS. 2A and 2B will be described.

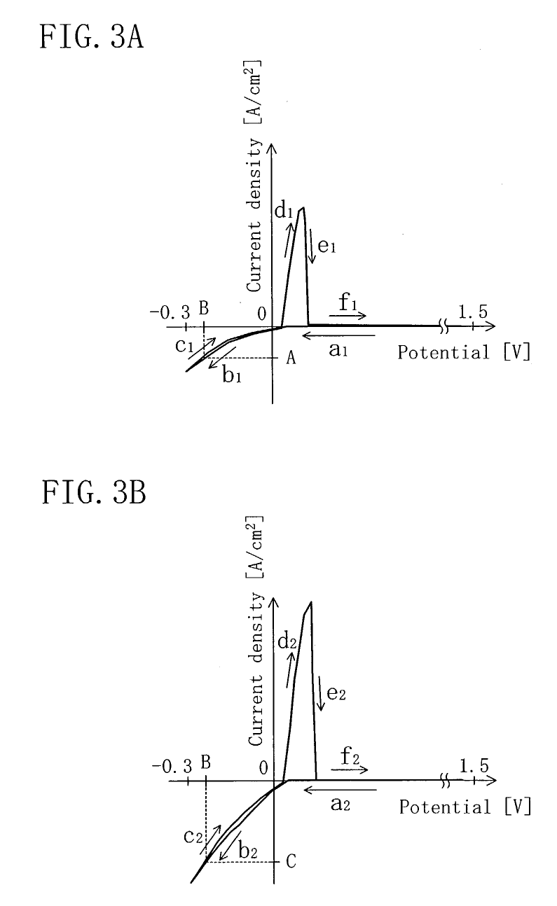

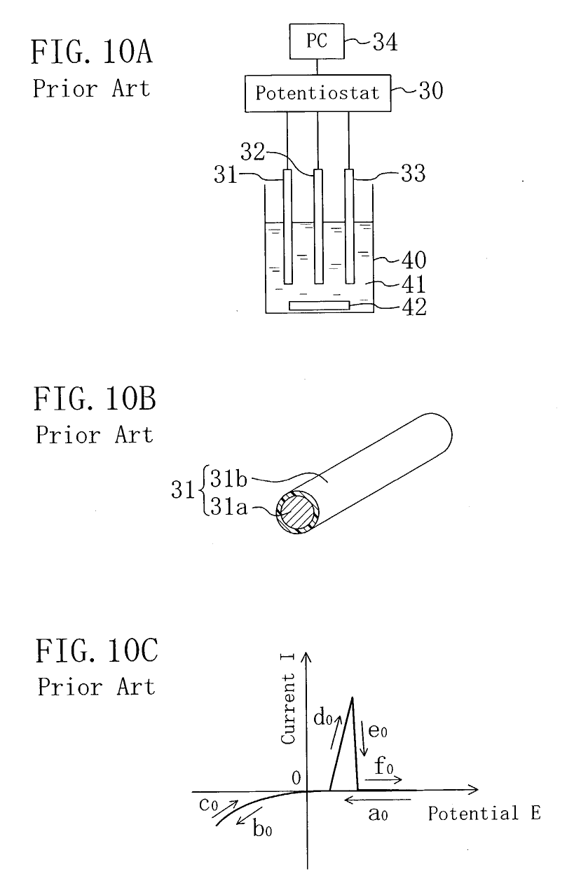

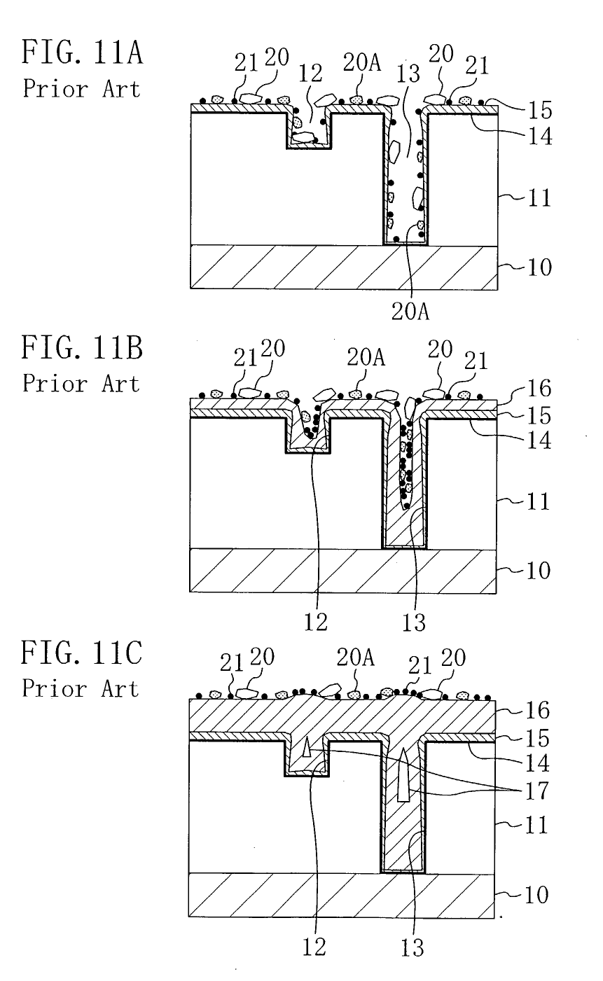

First, as shown in FIG. 2A, the switch 155 is operated so as to connect the second working electrode 153 having the second opening 153b, namely, the large opening, to the potentiostat 150, and the potential is applied to the second working electrode 153 so as to measure the current flowing between the second working electrode 153 and the auxiliary electrode 154 by using the potentiostat 150. At this point, in the same manner as in the plating solution evaluation method using the conventional CVS apparatus (shown in FIG. 10A), the potential of the second working electrode 153 on the basis of the reference electrode 151 (hereinafter simply referred to as the potential of the second working electrode 153) is reciprocated within a predetermined range (between, for example, +1.5 V and −0.3 V). FIG. 3A shows the thus obtained relationship between the current flowing to the second working electrode 153 and the potential of the second working electrode 153 (namely, a current-voltage characteristic). In FIG. 3A, the ordinate indicates, instead of the current flowing to the second working electrode 153, a current density obtained by dividing the value of the current flowing to the second working electrode 153 by a total value of opening areas of the second openings 153b provided on the second working electrode 153. In FIG. 3A, in consideration of the direction of the current, the current density is shown in both the positive and negative directions of the ordinate.

As shown in FIG. 3A, even when the potential of the second working electrode 153 is first lowered, no current flows to the second working electrode 153 (as shown with an arrow a₁). When the potential of the second working electrode 153 is further lowered, a reduction current of Cu ions flows to the second working electrode 153 (as shown with an arrow b₁). At this point, reduced Cu deposits on the second working electrode 153. Next, when the potential of the second working electrode 153 is started to be increased, the amplitude (absolute value) of the current flowing to the second working electrode 153 is decreased (as shown with an arrow c₁). When the potential of the second working electrode 153 is further increased, an oxidation current starts to flow to the second working electrode 153 (as shown with an arrow d₁), and hence, the Cu having been deposited on the second working electrode 153 is oxidized to be dissolved in the plating solution. Thereafter, when the whole Cu having been deposited on the second working electrode 153 is dissolved, the current flowing to the second working electrode 153 becomes minimal (as shown with arrows e₁ and f₁).

Next, on the basis of the current-voltage characteristic shown in FIG. 3A, a potential value B corresponding to a current density value A (of, for example, 10 mA/cm²) employed in the plating processing shown in FIG. 1B, namely, in the actual plating process, is obtained. At this point, in the case where the plated copper film 106 is grown by the plating as a copper interconnect material on the semiconductor substrate 100 in the actual plating process, the most portion on the semiconductor substrate 100 is flat and the area occupied by the contact hole 103 and the like is comparatively small. Therefore, in the case where the opening area of the second openings 153b provided on the second working electrode 153 is sufficiently larger than the opening area of the contact hole 103 and the like, the potential value for growing the plated copper film 106 by the plating on the semiconductor substrate 100 is regarded to correspond to the value B.

Next, as shown in FIG. 2B, the switch 155 is operated so as to connect the first working electrode 152 having the first opening 152b, namely, the fine opening, to the potentiostat 150, and the potential is applied to the first working electrode 152 so as to measure a current flowing between the first working electrode 152 and the auxiliary electrode 154 by using the potentiostat 150. At this point, similarly to the case of the potential application to the second working electrode 153, the potential of the first working electrode 152 on the basis of the reference electrode 151 (hereinafter simply referred to as the potential of the first working electrode 152) is reciprocated within a predetermined range (between, for example, +1.5 V and −0.3 V). FIG. 3B shows the thus obtained relationship between the current flowing to the first working electrode 152 and the potential of the first working electrode 152 (namely, a current-voltage characteristic). In FIG. 3B, the ordinate indicates, instead of the current flowing to the first working electrode 152, a current density obtained by dividing the current value by a total value of the opening areas of the first openings 152b provided on the first working electrode 152. Also in FIG. 3B similarly to FIG. 3A, in consideration of the direction of the current, the current density is shown in the positive direction and the negative direction of the ordinate.

As shown in FIG. 3B, when the potential of the first working electrode 152 is first lowered, no current flows to the first working electrode 152 (as shown with an arrow a₂). When the potential of the first working electrode 152 is further lowered, a reduction current of Cu ions flows to the first working electrode 152 (as shown with an arrow b₂). At this point, reduced Cu deposits on the first working electrode 152. Next, when the potential of the first working electrode 152 is started to be increased, the amplitude (absolute value) of the current flowing to the first working electrode 152 is decreased (as shown with an arrow c₂). When the potential of the first working electrode 152 is further increased, an oxidation current starts to flow to the first working electrode 152 (as shown with an arrow d₂), and hence, the Cu having been deposited on the first working electrode 152 is oxidized to be dissolved in the plating solution. Thereafter, when the whole Cu having been deposited on the first working electrode 152 is dissolved, the current flowing to the first working electrode 152 becomes minimal (as shown with arrows e₂ and f₂).

Subsequently, on the basis of the current-voltage characteristic shown in FIG. 3B, a current density value C corresponding to the potential value B is obtained. At this point, the value of the potential for growing the plated copper film 106 on the semiconductor substrate 100 by the plating is regarded to correspond to the value B, and the first opening 152b has the opening diameter and depth equivalent to those of the contact hole 103 or the like provided on the semiconductor substrate 100. Accordingly, the current density value C is regarded to correspond to the current density value on the bottom of the contact hole 103 or the like in the plating processing shown in FIG. 1B.

Next, a ratio C/A, that is, a ratio of the current density value C of the first working electrode 152 to the current density value A of the second working electrode 153, is calculated by using the personal computer 156. Thereafter, the calculated ratio C/A is compared with a prescribed value K previously calculated through an experiment or the like. When the ratio C/A is smaller than the prescribed value K, in other words, when the current density value C, namely, the amount of deposited plating in the contact hole 103 or the like, is small, it is evaluated that the plating solution 161 has been degraded due to the influence of a reaction by-product of an additive included in the plating solution 161, and hence, it is determined that it is time for exchanging the plating solution 161. Therefore, whole or part (namely, for example, approximately 10% through 80% of the whole volume of the plating solution 161) is exchanged with a fresh plating solution.

As described so far, according to Embodiment 1, the value of a current flowing through the plating solution 161 to the first working electrode 152 whose base is exposed in the first opening 152b is measured, and the value of a current flowing through the plating solution 161 to the second working electrode 153 whose base is exposed in the second opening 153b having a larger opening area than the first opening 152b is measured. Therefore, when the opening diameter and the depth of the first opening 152b is set to be equivalent to those of a fine opening such as the contact hole 103 provided on the semiconductor substrate 100 corresponding to the substrate to be plated, the following effects can be attained: The amount of deposited plating, namely, the plating rate (i.e., the amount of deposited plating per unit time), within the fine opening can be compared with the plating rate outside the fine opening, namely, on the semiconductor substrate 100. In other words, the influence of an additive and a reaction by-product thereof included in the plating solution 161 on the plating growths respectively inside and outside of the fine opening can be directly obtained. Accordingly, the degree of degradation of the plating solution 161 can be accurately evaluated in a short time, so that time when the defective burying of the plated copper film 106 occurs within the fine opening, namely, the time for exchanging the plating solution 161, can be accurately obtained in a short time. As a result, the plating solution 161 can be exchanged at good timing before the occurrence of the defective burying, and hence, the plated copper film 106 can be definitely buried by the electroplating within the fine openings, that is specifically, the interconnect forming recesses such as the contact hole 103 or the interconnect groove 102, provided on the semiconductor substrate 100 without wasting cost and time.

Also, according to Embodiment 1, the ratio C/A, that is, the ratio of the current density value C of the current flowing to the first working electrode 152 to the current density value A of the current flowing to the second working electrode 153, is calculated to be compared with the prescribed value K, so as to exchange the plating solution 161 on the basis of the comparison result. Therefore, the plating solution 161 can be exchanged easily at good timing.

In Embodiment 1, the first opening 152b preferably has an opening diameter and a depth equivalent to those of a recess (for example, the contact hole 103) having the largest aspect ratio that is the most difficult to fill by the plating among the interconnect groove 102 and the contact hole 103, namely, among all the interconnect forming recesses, provided on the semiconductor substrate 100. Thus, the time for exchanging the plating solution 161 can be more precisely obtained.

Furthermore, in Embodiment 1, the plating chamber 160 in which the plating processing shown in FIG. 1B is performed is used as the plating tank for containing the plating solution 161 to be evaluated by the plating solution evaluation apparatus of this embodiment shown in FIGS. 2A and 2B. Instead, a plating cell for containing a portion of the plating solution extracted for measurement from the plating chamber 160 may be used, or a plating solution tank for performing circulative filtration of the plating solution with the plating chamber 160 may be used.

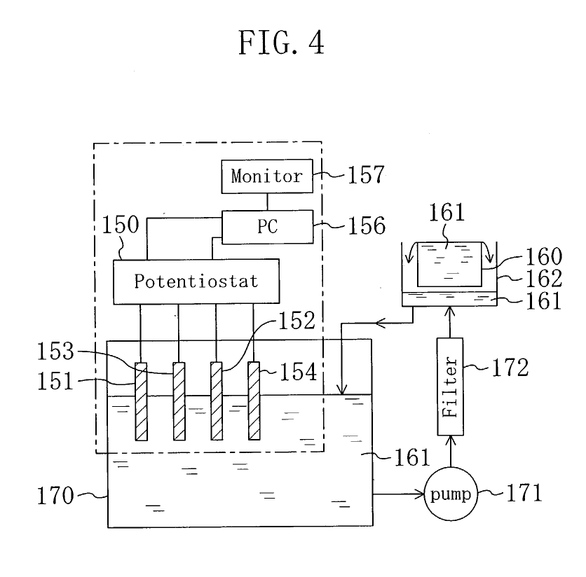

FIG. 4 shows evaluation of a plating solution contained in the above-described plating solution tank by using the plating solution evaluation apparatus of this embodiment. In FIG. 4, like reference numerals are used to refer to like elements included in the plating solution evaluation apparatus of this embodiment shown in FIGS. 2A and 2B so as to omit the description. As shown in FIG. 4, the reference electrode 151, the first working electrode 152, the second working electrode 153 and the auxiliary electrode 154 are immersed in the plating solution 161 contained in a plating solution tank 170. The plating solution tank 170 contains several tens through several hundreds liters of plating solution 161, and the plating solution 161 is fed to the plating chamber 160 by a pump 171 at a rate of several through several tens liters per minute. During the feeding, particles and air bubbles included in the plating solution 161 are removed by a filter 172. A portion of the plating solution 161 having been used for the plating processing in the plating chamber 160 is circulated through a recovery tank 162 to the plating solution tank 170 for reuse. In the plating solution evaluation apparatus of this embodiment shown in FIG. 4, a monitor 157 for checking the result of the processing performed by the personal computer 156 is connected to the personal computer 156.

Now, a method for obtaining the prescribed value K used in the plating solution evaluation using the ratio C/A (namely, the ratio of the current density value C of the first working electrode 152 to the current density value A of the second working electrode 153) will be described.

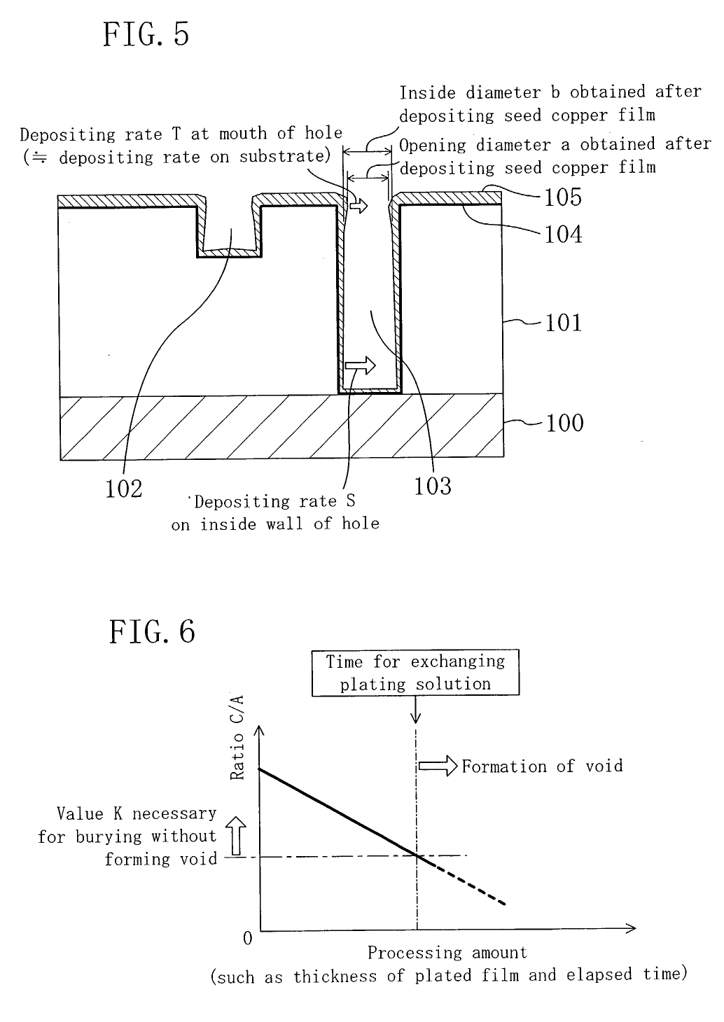

FIG. 5 is a diagram for showing an exemplified method for obtaining the prescribed value K. In FIG. 5, like reference numerals are used to refer to like elements shown in FIG. 1A showing one procedure in the method for fabricating an electronic device of this embodiment, so as to omit the description.

As shown in FIG. 5, when the seed copper film 105 is deposited above the semiconductor substrate 100 with the tantalum nitride film 104 serving as the adhesion layer sandwiched therebetween after forming the interconnect groove 102 and the contact hole 103 in the interlayer insulating film 101 formed on the semiconductor substrate 100, the seed copper film 105 overhangs at the mouth of, for example, the contact hole 103. As a result, the opening diameter a of the resultant contact hole 103 (namely, the opening diameter obtained after depositing the seed copper film) is smaller than that obtained before depositing the seed copper film. When it is assumed, for example, that the opening diameter of the contact hole 103 is approximately 200 nm before depositing the seed copper film and the thickness of the seed copper film 105 is approximately 150 nm, the opening diameter a obtained after depositing the seed copper film is approximately 100 nm. On the other hand, the thickness of the seed copper film 105 on the inside wall of the contact hole 103 is at least approximately 5 nm or less, and hence, the inside diameter b of the contact hole 103 (the diameter in a portion other than the mouth of the contact hole 103) obtained after depositing the seed copper film is approximately 190 nm, which is obtained as 200−5×2=190.

In order to fill the contact hole 103 with the plated copper film 106 without forming a void, the inside of the contact hole 103 should be filled with the plated copper film 106 before the mouth of the contact hole 103 is closed by the plated copper film 106. Accordingly, when the depositing rate of the plated copper film 106 at the mouth of the contact hole 103 (namely, the depositing rate of the plated copper film 106 on the semiconductor substrate 100) is indicated as T and the depositing rate of the plated copper film 106 on the inside wall of the contact hole 103 is indicated as S, the relationship of a/T>b/S should be satisfied. On the other hand, the depositing rate T corresponds to the current density value A of the second working electrode 153, and the depositing rate S corresponds to the current density value C of the first working electrode 152, namely, the relationship of C/A=S/T>b/a=K holds. At this point, when the prescribed value K is obtained by assuming, for example, that the diameter a is 100 nm and the diameter b is 190 nm as described above, K=1.9. In this case, when the ratio C/A is larger than 1.9, the contact hole 103 can be filled with the plated copper film 106 without forming a void. On the contrary, when the ratio C/A is smaller than 1.9, it is necessary to exchange the plating solution.

In another exemplified method for obtaining the prescribed value K, recesses are previously filled without forming a void or with forming a void by repeatedly performing the plating processing with the plating conditions (such as the current density and the concentration of the additive) variously varied. At this point, the ratio C/A in each plating condition is obtained by using the plating solution evaluation apparatus of this embodiment, and the obtained ratio is compared with the actual result of burying. Thus, the prescribed value K corresponding to a threshold value of the formation of a void can be obtained. In the actual fabrication of devices, the change of the ratio C/A against the plating processing amount (namely, the thickness of a plated film or the elapsed time) is plotted, for example, as shown in FIG. 6. Thus, the time for exchanging the plating solution can be determined on the basis of the obtained prescribed value K.

### EMBODIMENT 2

A method for fabricating a plating solution evaluation apparatus according to Embodiment 2, and specifically, a method for forming a working electrode used in the plating solution evaluation apparatus of Embodiment 1, will now be described with reference to the accompanying drawings.

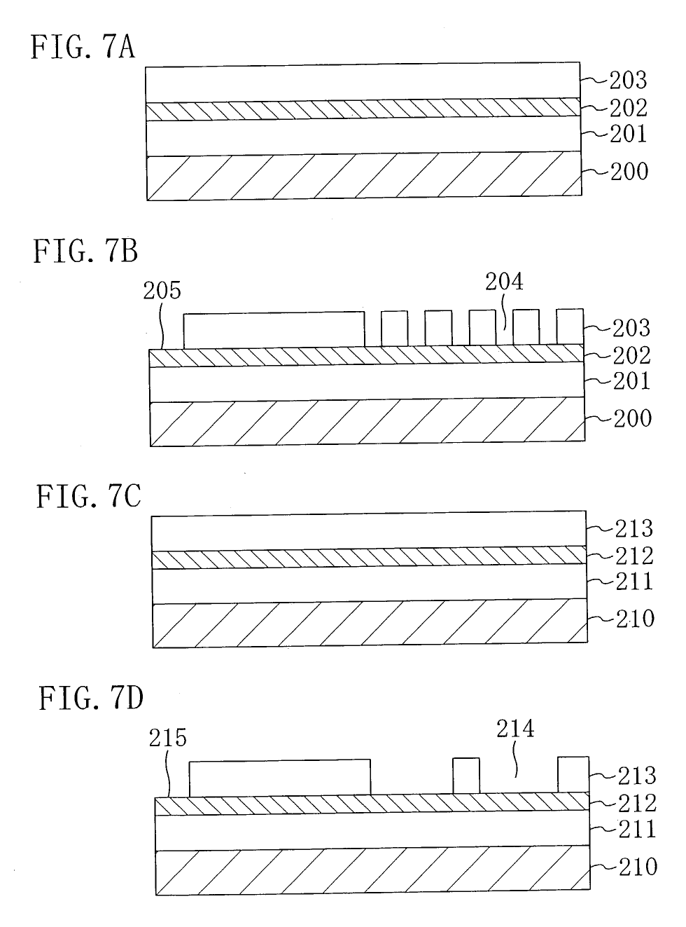

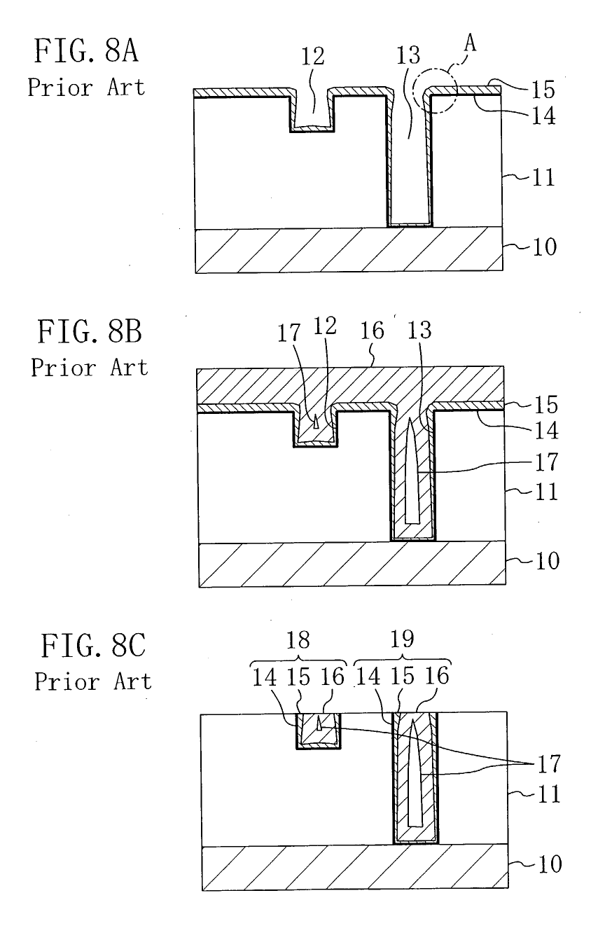

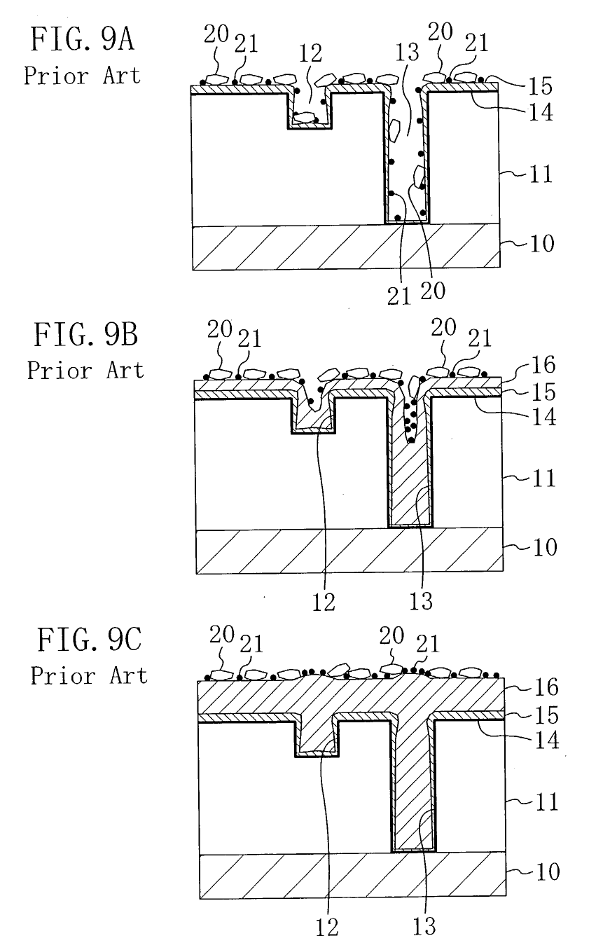

FIGS. 7A through 7D are cross-sectional views for showing procedures in the method for fabricating a plating solution evaluation apparatus of Embodiment 2.

First, as shown in FIG. 7A, on a semiconductor substrate 200 covered with a first insulating film 201, a first conducting film 202 of, for example, platinum is formed by, for example, the sputtering or evaporation. The first conducting film 202 corresponds to the base of the first working electrode 152 used in the plating solution evaluation apparatus of Embodiment 1 shown in FIGS. 2A and 2B. Next, a second insulating film 203 is formed on the first conducting film 202 by, for example, chemical vapor deposition or the like. At this point, the thickness of the second insulating film 203 is set to a value equivalent to the depth of one of interconnect forming recesses (for example, a contact hole) provided on a substrate to be plated (i.e., a substrate to be plated by using a plating solution that is analyzed with the working electrode fabricated in this embodiment).

Next, as shown in FIG. 7B, at least one first opening 204 reaching the first conducting film 202 is formed in the second insulating film 203 by the lithography and the dry etching. At this point, the opening diameter of each first opening 204 is set to be equivalent to the opening diameter of, for example, the contact hole provided on the substrate to be plated. Also, the first conducting film 202 is exposed by partly removing the second insulating film 203, so as to form a first takeoff electrode portion 205 which is made from an exposed portion of the first conducting film 202 and on which a measurement terminal is provided.

In the procedures shown in FIGS. 7A and 7B, a working electrode (corresponding to the first working electrode 152 of Embodiment 1) having the first opening 204 (the fine opening) with an opening diameter and a depth equivalent to those of, for example, the contact hole provided on the substrate to be plated by the plating processing is fabricated. When this working electrode is used, the influence of an additive and its reaction by-product (such as a decomposed component of the additive) on the plating growth within the contact hole provided on the substrate to be plated can be directly measured during the plating processing for fabricating an actual device.

Subsequently, as shown in FIG. 7C, on a semiconductor substrate 210 covered with a third insulating film 211, a second conducting film 212 of, for example, platinum is formed by, for example, the sputtering or the evaporation. The second conducting film 212 corresponds to the base of the second working electrode 153 of the plating solution evaluation apparatus of Embodiment 1 shown in FIGS. 2A and 2B. Next, a fourth insulating film 213 is formed on the second conducting film 212 by, for example, the chemical vapor deposition.

Then, as shown in FIG. 7D, at least one second opening 214 reaching the second conducting film 212 is formed in the fourth insulating film 213 by the lithography and the dry etching. At this point, the opening diameter of each second opening 214 is set to be sufficiently larger than the opening diameter of the first opening 204. Also, the second conducting film 212 is exposed by partly removing the fourth insulating film 213, so as to form a second takeoff electrode portion 215 which is made from an exposed portion of the second conducting film 212 and on which a measurement terminal is provided.

In the procedures shown in FIGS. 7C and 7D, a working electrode (corresponding to the second working electrode 153 of Embodiment 1) having the second opening 214 with an opening diameter sufficiently larger than that of the first opening 204 is fabricated. When this working electrode is used, the influence of an additive and its reaction by-product (such as a decomposed component of the additive) on the plating growth on the substrate to be plated can be directly measured during the plating processing for fabricating an actual device.

As described so far, according to Embodiment 2, the first and second working electrodes of the plating solution evaluation apparatus of Embodiment 1 can be simply and definitely formed.

In the case where the first working electrode of the plating solution evaluation apparatus of Embodiment 1 is formed in Embodiment 2, the first opening 204 preferably has an opening diameter and a depth equivalent to those of a recess (for example, a contact hole) having the largest aspect ratio that is the most difficult to fill by the plating among all interconnect forming recesses provided on the substrate to be plated. Thus, the time for exchanging the electroplating solution can be precisely obtained by using the thus formed working electrode.

What is claimed is:

1. A plating solution evaluation apparatus for evaluating an electroplating solution including an additive, comprising:
a first working electrode including a first conducting layer, a first insulating layer covering said first conducting layer and a first opening formed in said first insulating layer for exposing said first conducting layer;
a second working electrode including a second conducting layer, a second insulating layer covering said second conducting layer and a second opening that is formed in said second insulating layer for exposing said second conducting layer and has an opening area larger than that of said first opening; and
current measuring means for measuring a value of a current flowing to one electrode out of said first working electrode and said second working electrode with potential on the basis of a reference electrode selectively applied to said one electrode.

2. The plating solution evaluation apparatus of claim 1,
wherein said first opening has an opening diameter and a depth equivalent to those of an interconnect forming recess having the largest aspect ratio among one or more interconnect forming recesses provided on a substrate to be plated by using said electroplating solution.

3. A plating solution evaluation method for evaluating an electroplating solution including an additive, comprising the steps of:
measuring a value of a first current flowing to a first working electrode, which includes a first conducting layer, a first insulating layer covering said first conducting layer and a first opening formed in said first insulating layer for exposing said first conducting layer, with said first working electrode immersed in said electroplating solution and with first potential on the basis of a reference electrode applied to said first working electrode; and
measuring a value of a second current flowing to a second working electrode, which includes a second conducting layer, a second insulating layer covering said second conducting layer and a second opening that is formed in said second insulating layer for exposing said second conducting layer and has an opening area larger than that of said first opening, with said second working electrode immersed in said electroplating solution and with second potential on the basis of said reference electrode applied to said second working electrode.

4. The plating solution evaluation method of claim 3, further comprising the steps of:
calculating a current density of said first current on the basis of the opening area of said first opening and said measured value of said first current;
calculating a current density of said second current on the basis of the opening area of said second opening and said measured value of said second current; and
calculating a ratio of said current density of said first current to said current density of said second current.

5. The plating solution evaluation method of claim 3,
wherein said first opening has an opening diameter and a depth equivalent to those of an interconnect forming recess having the largest aspect ratio among one or more interconnect forming recesses provided on a substrate to be plated by using said electroplating solution.

6. A plating solution control method for controlling an electroplating solution including an additive, comprising the steps of:
measuring a value of a first current flowing to a first working electrode, which includes a first conducting layer, a first insulating layer covering said first conducting layer and a first opening formed in said first insulating layer for exposing said first conducting layer, with said first working electrode immersed in said electroplating solution and with first potential on the basis of a reference electrode applied to said first working electrode;
measuring a value of a second current flowing to a second working electrode, which includes a second conducting layer, a second insulating layer covering said second conducting layer and a second opening that is formed in said second insulating layer for exposing said second conducting layer and has an opening area larger than that of said first opening, with said second working electrode immersed in said electroplating solution and with second potential on the basis of said reference electrode applied to said second working electrode;
calculating a current density of said first current on the basis of the opening area of said first opening and said measured value of said first current;
calculating a current density of said second current on the basis of the opening area of said second opening and said measured value of said second current;
calculating a ratio of said current density of said first current to said current density of said second current; and
comparing said calculated ratio with a given value, and when said calculated ratio is smaller than said given value, exchanging part or whole of said electroplating solution with a fresh electroplating solution.

7. The plating solution control method of claim 6,
wherein said first opening has an opening diameter and a depth equivalent to those of an interconnect forming recess having the largest aspect ratio among one or more interconnect forming recesses provided on a substrate to be plated by using said electroplating solution.

8. A method for fabricating a plating solution evaluation apparatus for evaluating an electroplating solution including an additive, comprising:
a step of forming a working electrode,
wherein the step of forming a working electrode includes the sub-steps of:
forming a conducting layer corresponding to a base of said working electrode on a substrate covered with a first insulating film;
forming a second insulating film on said conducting film;
forming an opening reaching said conducting film in said second insulating film; and
exposing said conducting film by partly removing said second insulating film, whereby forming a takeoff electrode portion.

9. The method for fabricating a plating solution evaluation apparatus of claim 8,
wherein said opening has an opening diameter and a depth equivalent to those of an interconnect forming recess having the largest aspect ratio among one or more interconnect forming recesses provided on a substrate to be plated by using said electroplating solution.

10. An apparatus for fabricating an electronic device in which a substrate having one or more interconnect forming recesses is immersed in a plating solution for burying a metal film in said interconnect forming recesses by electroplating, comprising:
a first working electrode including a first conducting layer, a first insulating layer covering said first conducting layer, and a first opening that is formed in said first insulating layer for exposing said first conducting layer and has an opening diameter and a depth equivalent to those of one of said interconnect forming recesses;
a second working electrode including a second conducting layer, a second insulating layer covering said second conducting layer, and a second opening that is formed in said second insulating layer for exposing said second conducting layer and has an opening area larger than that of said first opening; and
current measuring means for independently measuring a value of a current flowing to one electrode out of said first working electrode and said second working electrode with potential on the basis of a reference electrode selectively applied to said one electrode.

11. The apparatus for fabricating an electronic device of claim 10,
wherein said first opening has an opening diameter and a depth equivalent to those of one interconnect forming recess having the largest aspect ratio among said interconnect forming recesses.

12. A method for fabricating an electronic device comprising the steps of:
forming one or more interconnect forming recesses in an interlayer insulating film formed on a substrate; and
burying a metal film in said interconnect forming recesses by electroplating with said substrate immersed in a plating solution,
wherein the step of burying a metal film includes the sub-steps of:
measuring a value of a first current flowing to a first working electrode, which includes a first conducting layer, a first insulating layer covering said first conducting layer and a first opening that is formed in said first insulating layer for exposing said first conducting layer and has an opening diameter and a depth equivalent to those of one of said interconnect forming recesses, with said first working electrode immersed in said plating solution and with first potential on the basis of a reference electrode applied to said first working electrode; and
measuring a value of a second current flowing to a second working electrode, which includes a second conducting layer, a second insulating layer covering said second conducting layer, and a second opening that is formed in said second insulating layer for exposing said second conducting layer and has an opening area larger than that of said first opening, with said second working electrode immersed in said plating solution and with second potential on the basis of said reference electrode applied to said second working electrode.

13. The method for fabricating an electronic device of claim 12, further comprising the steps of:
calculating a current density of said first current on the basis of the opening area of said first opening and said measured value of said first current;
calculating a current density of said second current on the basis of the opening area of said second opening and said measured value of said second current;
calculating a ratio of said current density of said first current to said current density of said second current; and
comparing said calculated ratio with a given value, and when said calculated ratio is smaller than said given value, exchanging part or whole of said plating solution with a fresh plating solution.

14. The method for fabricating an electronic device of claim 12,
wherein said first opening has an opening diameter and a depth equivalent to those of an interconnect forming recess having the largest aspect ratio among said interconnect forming recesses.
